(19) United States
(12) Patent Application Publication
(10) Pub. No.: US 2014/0125811 A1
(43) Pub. Date: May 8, 2014

(54) SYSTEM, METHOD AND COMPUTER PROGRAM PRODUCT FOR IDENTIFYING CHEMICAL COMPOSITION OF OPTICALLY LIFTED LATENT PRINTS AND CONTAMINANTS

(71) Applicant: LOCKHEED MARTIN CORPORATION, Bethesda, MD (US)

(72) Inventor: Edward Jozef Miesak, Windermere, FL (US)

(73) Assignee: LOCKHEED MARTIN CORPORATION, Bethesda, MD (US)

(21) Appl. No.: 14/069,470

(22) Filed: Nov. 1, 2013

Related U.S. Application Data
(60) Provisional application No. 61/724,101, filed on Nov. 8, 2012.

(51) Int. Cl. G01N 21/35; H04N 5/32

(52) U.S. Cl. CPC G01N 21/3581; H04N 5/32
USPC 348/164

(57) ABSTRACT

A system including an imaging device with a sensor having at least two dimensions operating in a long wave infrared emission spectrum to collect images of a latent print or a contaminant at different illuminating wavelengths, a storage device comprising a database of known material spectra, and a processor configured to determine an absorption spectrum per image based on a detection of high contrast being associated with low optical transmission and a detection of low contrast being associated with a high optical transmission and to compare the determined absorption spectrum with the known material spectra to determine a material identification of the latent print or the contaminant is disclosed. A method and a non-transitory processor readable storage medium are also disclosed.

### CROSS-REFERENCE TO RELATED APPLICATIONS

This application claims the benefit of U.S. Provisional Application No. 61/724,101 filed Nov. 8, 2012, and incorporated herein by reference in its entirety.

### BACKGROUND

Embodiments relate to an imaging system and, more particularly, to a system and method to identify a chemical composition of an optically detected latent print or contaminant upon a surface.

A latent print may be invisible fingerprint impression, footprint impression, or palm print impression left on a surface following surface contact caused by the perspiration on ridges of an individual's skin coming in contact with a surface and leaving perspiration, sebum, waxes, oils, etc., behind, making an invisible or partially visible impression on the surface as a result. Perspiration is known to contain water, salt, amino acids, and oils, which allows impressions to be made. The natural oils of the body, or non-bodily fluids, preserve the print, where the impression left is utterly distinct so that no two humans have the same fingerprints.

Conventional methods for extracting fingerprints usually involve adding chemicals or powders to the print. Such conventional methods can present an immediate dilemma in that they force the investigator to make a decision as to whether to dust for prints versus swabbing for deoxyribonucleic acid (“DNA”) evidence. Either approach results in destroying, or removing, the prints as they are originally found since the prints are no longer on their original surface.

Automatic non-contact latent fingerprint detection systems are also known that avoid the need to add chemicals or powders that can disturb the surface chemicals of the fingerprint. Such systems generally include a light source, utilize diffuse reflectance ((reject specular reflection (glare)) and some may use specular reflection, and are generally limited to fingerprinting the area of one's finger, or an area about that size.

Lifting a latent fingerprint off smooth flat surfaces having a mirror-like surface is most easily done by exploiting scattered light by scattering light off the latent fingerprint into a camera lens or away from the camera lens. Optical detection is usually critically dependent on image contrast. Latent prints are very low contrast objects and therefore using only existing optical techniques when the print is on a rough surface is not practical.

However, depending on the material of the surface to which the latent fingerprint is on, the scattered light from the surface may act as a noise background to the latent fingerprint image. As the surface roughness increases so does the amount of scattered light and hence contributed noise. At some point the noise obscures the image rendering the latent fingerprint invisible. Using low optical transmission to add image contrast allows the user to lift the latent fingerprint off a non-fluorescing, or very weakly fluorescing, roughened surface that has significant amounts of optical scatter.

Additionally, optically lifting a latent print does not provide a collector an opportunity to ascertain the chemical content of the material which holds the latent print, or the material of a contaminant. Scanning techniques such as Fourier transform infrared spectroscopy (“FTIR”), Raman spectroscopy, or laser-induced breakdown spectroscopy (“LIBS”) require huge amounts of time to complete. As a non-limiting example, a single Raman spectrum may take from half a minute to 10 minutes to complete and obtain. One square inch of a target area requires one million spectra in order to meet the resolution requirements set by law enforcement (1000 dots per inch (“DPI”)). Assuming that each spectrum needed 30 seconds, no wasted time between scans, and operating 24 hours a day, collecting one square inch will take 347 days.

Though techniques for reducing the required scan time by as much as 1024 times are possible, such techniques are generally accomplished by utilizing a two dimensional sensor rather than a single element sensor to collect the sample spectra. Using this technique it is possible to collect 1024 spectra within each sample time. This reduces the total collection time from 347 days to 8.14 hours. This would be done using a sensor having at least 1024 by 1024 pixels.

Entities wishing to detect a latent print or contaminant and to determine the chemical composition of the material of the latent print or contaminant would benefit from a system and method where obtaining chemical composition may be accomplished during a time frame it would take to optically lift the latent print or contaminant.

### SUMMARY

Embodiments relate to a system, method and computer software product to identify a chemical composition of an optically detected latent print or contaminant upon a surface. The system comprises an imaging device with a sensor having at least two dimensions operating in a long wave infrared emission spectrum to collect images of a latent print or a contaminant at different illuminating wavelengths. The system also comprises a storage device comprising a database of known material spectra. The system also comprises a processor configured to determine an absorption spectrum per image based on a detection of high contrast being associated with low optical transmission and a detection of low contrast being associated with a high optical transmission and to compare the determined absorption spectrum with the known material spectra to determine a material identification of the latent print or the contaminant.

The method comprises collecting an optical image of a latent print or contaminant at a plurality of illuminating wavelengths with a sensor having at least two dimensions operating in a long wave infrared emission spectrum. The method also comprises measuring the optical image to determine image contrast of the image at a specific wavelength. The method also comprises determining an absorption spectrum, at discrete points of the image, based on a detection of a high contrast being associated with low optical transmission and detection of a low contrast being associated with a high optical transmission. The method further comprises comparing the determined absorption spectra at discreet image location with known spectra specific to known material to determine a material identification.

The computer software program is a non-transitory processor readable storage medium which provides for an executable computer program product where the executable computer program product comprising a computer software code that, when executed on a processor, causes the processor to collect optical images of a latent fingerprint at a plurality of illuminating wavelengths with a sensor having at least two dimensions operating in a long wave infrared emission spectrum. The processor is also caused to determine image contrast for each image measured at a specific wavelength. The processor is also caused to determine an absorption spectrum, at discrete points of the image, per image based on a detection of a high contrast being associated with low optical transmission and detection of a low contrast being associated with a high optical transmission. The processor is further caused to compare the determined absorption spectra at discreet image location with known spectra specific to known material to determine a material identification.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 discloses a plot illustrating transmission percentage versus wavelength in micrometers of an optical transmission curve of one particular fingerprint material;

FIG. 2 discloses a spectrum of vanillin;

FIG. 3 discloses a block diagram representing an embodiment of a system;

FIG. 4 discloses a representation of a scan direction with respect to camera pixels; and

FIG. 5 discloses a flowchart illustrating an embodiment of a method.

### DETAILED DESCRIPTION

Embodiments are described herein with reference to the attached figures, wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Though embodiments are disclosed with respect to latent fingerprints, the embodiments are also applicable to other latent markings or prints, such as, but not limited to, a footprint, a palm print, etc. Embodiments are also applicable to other surface contaminants. As used herein, “latent print” comprises a latent fingerprint and other imprints that may be recognizable to distinguish an entity from another. Latent fingerprints, which are impressions left by the friction, ridges of a human finger, may be composed of almost any material, including, but not limited to, grease, oil, sweat, wax, etc. “Latent” as used with respect to fingerprints and/or other prints means a chance or accidental impression left on a surface, regardless of whether visible or invisible at time of deposition. The term “contaminant” is also used herein. This term is not limited as it can also apply to a latent print. Other non-limiting examples of a contaminant may include blood, or other body fluids, oils, greases, dusts, dirt, water residue, other particulates, a fracture in a surface, a physical defect in the surface, etc.

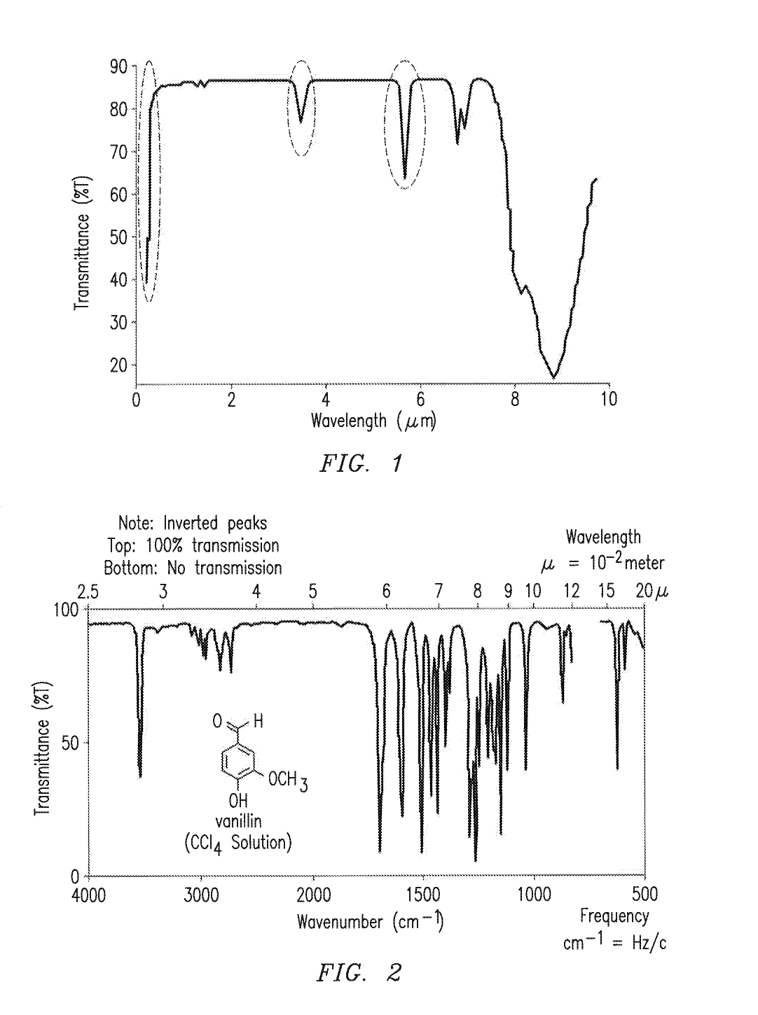

FIG. 1 shows a plot illustrating transmission percentage versus wavelength in micrometers of an optical transmission curve of a particular, or sample of, fingerprint material. Those skilled in the art recognize that other samples of fingerprint material will somewhat resemble this curve, but may differ slightly. Four regions are identified as marked where lower optical transmission exists. If a latent finger made of this material were photographed at one of these four regions, the image contrast would be higher than if the latent print were illuminated at a wavelength outside of one of these regions of lower transmission. The region closest to zero micrometers is in the ultraviolet-C (“UVC”) region. The region between 8 micrometers to 15 micrometers is the long wave infrared (“LWIR”) region.

FIG. 2 shows a spectrum of vanillin. Vanillin is an organic compound which is sometimes used as a flavoring agent in foods, beverages, and pharmaceuticals as it is a primary component of the extract of vanilla bean. Though vanillin is shown, a latent print may be composed of almost any material such as, but not limited to, grease, oil, sweat, wax, etc. Different materials making up the latent print will likely have different optical transmission curves. The differences in these curves may be used to identify the chemical composition of the latent print or contaminant material. Infrared spectrometers permit chemists to obtain absorption spectra of compounds that are a unique reflection of their molecular structure. An example of such a spectrum is that of the flavoring agent vanillin. The complexity of its spectrum is typical of most infrared spectra and illustrates their use in identifying substances. Each substance has a unique spectrum. Vast libraries of chemical absorption spectra exist to assist in the identification of materials by researchers.

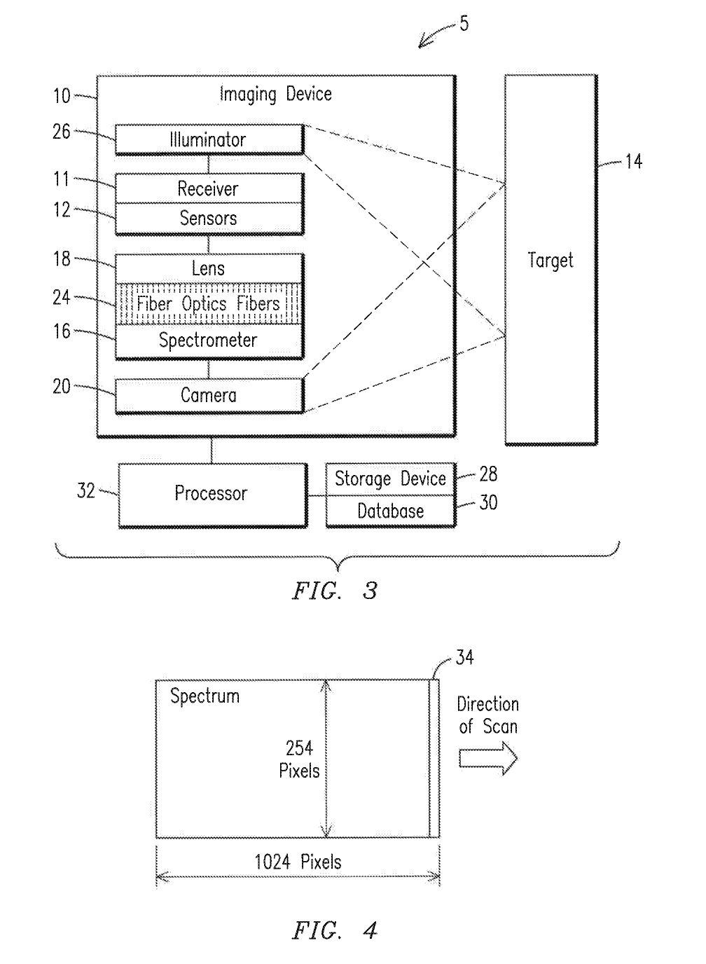

FIG. 3 discloses a block diagram representing an embodiment of a system for identifying chemical composition of an optically lifted latent fingerprint. The system 5 comprises an imaging device 10 having a receiver 11. The receiver 11 comprises at least one sensor 12 having at least two dimensions operating in an LWIR emission spectrum to collect images of the latent print or contaminant from a target 14 at different illuminating wavelengths. The target may not be a part of the system 5. A spectrometer 16 may be provided which is either a part of the imaging device 10 or is connected to the imaging device 10. In other non-limiting examples, a multispectral imaging device, a hyperspectral imaging device, a full spectral imaging device, etc., may be used in place of the spectrometer 16. In general, an instrument, device 16, or analyzer, to measure properties of light over a specific portion of the electromagnetic spectrum may be provided. This device 16 may also be referred to as a light measuring device 16. Each device 16 may require a specific light source. Thus, the use of the spectrometer 16 should not be considered limiting.

As further illustrated in FIG. 3, a lens 18 is provided along with a camera 20. Either the camera 20 or spectrometer 16 may have an intensified charged coupled device (“ICCD”) 22, or both may have the ICCD 22. The ICCD 22 is a charged coupled device (“CCD”) that is optically connected to an image intensifier that is mounted in front of the CCD. As a non-limiting example, the ICCD 22 may view images at a specific resolution, such as, but not limited to, 1024×256 pixels. However, the ICCD 22 is not needed at the LWIR range since current ICCD technology does not work after 8 micrometers.

A plurality of fiber optic fibers 24 (where the box representing the plurality of fiber optic fibers also illustrates individual fiber optic fibers) may be used to connect the lens 18 of the imaging device 10 to the spectrometer 16. Each fiber 24 may correspond to a position in space along the horizontal axis. Though the use of optic fibers 24 is disclosed, they are not necessarily required. Based on an orientation of an orthogonal axis of the spectrometer 16 with respect to the lens 18, it may be possible to exclude use of the optic fibers. This is possible because the spectrometer 16 generally disperses light into a spectrum in only one axis where the orthogonal axis does not disperse light and hence may be used for imaging. As a non-limiting example, a bundle of optic fibers 24 is oriented such that each fiber 24 maps to one of the 255 camera pixels. Furthermore, each fiber 24 produces a spectrum individually resolvable by the ICCD 22 into 1,024 pixels. The camera 20 is then able to monitor at least 250 spots on the target 14 simultaneously. An illuminator 26, illuminating device or illumination source, may also be provided to illuminate the target 14.

FIG. 4 discloses a representation of a scan direction with respect to camera pixels. The system 5 scans along the sample, target, or surface in one direction. A composite image is built up from this scan. Spectrometers typically have a real or virtual slit 34 to increase the spectral resolution of the device. The scan may be performed as illustrated. The slit 34 is “normal” to the direction of the scan. This way, the pixels 1-254 do the imaging and the pixels 1-1024 resolve the spectrum at each of the 254 imaging pixels. By doing so, each imaging pixel in the composite image has an optical spectrum associated with it.

Referring back to FIG. 3, a storage device 28 comprising a database 30 of known material spectra may also be provided. A processor 32 may be provided to determine an absorption spectrum per image based on a detection of high contrast being associated with low optical transmission and a detection of low contrast being associated with a high optical transmission. The processor 32 may also be used to compare the determined absorption spectrum with the known material spectra to determine a material identification.

Thus, in essence, the system 5 uses optical transmission or absorption to enhance the image contrast of a latent fingerprint. If the image contrast of a fingerprint is high, then the optical transmission of the material making up the fingerprint is low and vice versa.

However, by utilizing the two dimensional sensors as disclosed, herein rather than a single element sensor to collect the sample spectra, it is possible to collect 1024 spectra within each sample time. This would be done using a sensor having at least 1024 by 1024 pixels. This reduces the total collection time from 347 days to 8.14 hours. Reducing the time it takes to collect a single spectrum from 30 seconds to less than 40 milliseconds is done by using Long Wave Infrared (“LWIR”) light. The LWIR light may illuminate a sample containing all the wavelengths needed to sufficiently identify the fingerprint material. The image spectrum may be collected as fast as the camera sensor(s) can operate. As a non-limiting example, a standard long wave sensitive camera, such as, but not limited to, a forward looking infrared (“FLIR”) camera has a sensor of 640×480 pixels and can capture thirty (30) frames per second. The 640 side may be used to scan the image and the 480 side may be used to capture the spectra. The amount of time to scan one square inch at 1,000 DPI is calculated below:

$$\frac{1 \text{,} 000 \text{,} 000}{30 \times 640} = 52.1 seconds$$

In operation, the imaging device 10 comprises a wide field of view spectrally resolved receiver 11 operable in the LWIR optical spectrum, namely, having a wavelength ranging between approximately 8 micrometers to 10 micrometers. The receiver 11, with its sensor(s), each having at least two dimensions, may spectrally resolve discreet points along a horizontal axis of a targeted area. The receiver 11 may be connected to the spectrometer 16. As discussed above, the spectrometer may be eliminated where either a multispectral imaging device, a hyperspectral imaging device, a full spectral imaging device, etc., is used instead, where the device used may require a specific light source.

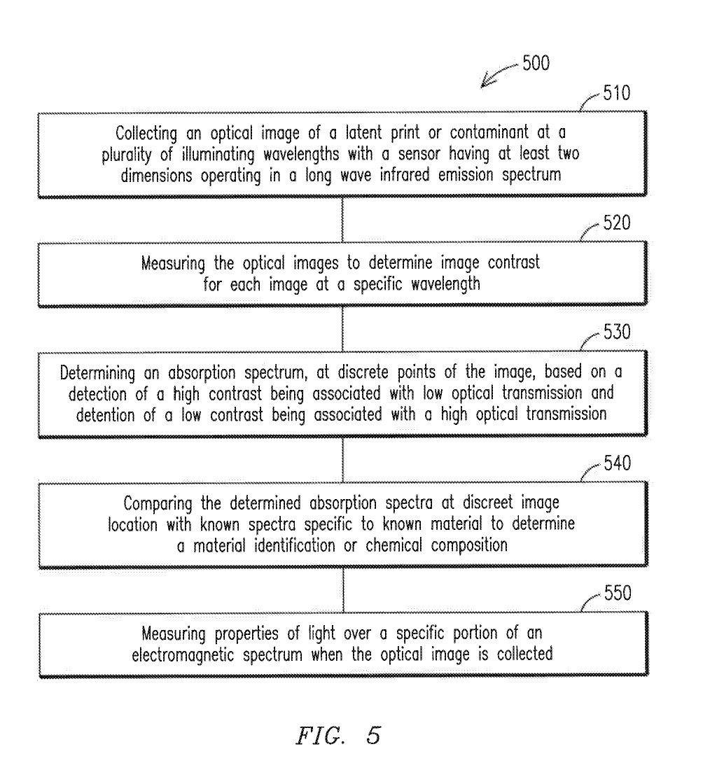

FIG. 5 discloses flowchart illustrating an embodiment of a method for identifying chemical composition of an optically lifted latent fingerprint. The method 500 comprises collecting optical images of a latent fingerprint at a plurality of illuminating wavelengths with a sensor having at least two dimensions operating in a long wave infrared emission spectrum, at 510, where the wavelengths may be emitted simultaneously or separately. The method 500 further comprises measuring the images to determine image contrast for each image at specific wavelengths, at 520. The method 500 further comprises determining an absorption spectrum at discreet points of the image per image based on a detection of high contrast being associated with low optical transmission and a detection of low contrast being associated with high optical transmission, at 530. The method further comprises comparing the determined absorption spectra at discreet image locations with known spectra specific to known material to determine material identification, or chemical composition of the material, at 540, making up the latent print or contaminant.

The method 500 may also comprise measuring properties of light over a specific portion of an electromagnetic spectrum when the optical image is collected, at 550. Though the steps illustrated in the flowchart of the method and provided in a particular sequence, this sequence is not meant to be limiting as those skilled in the art will recognize that these steps may be performed in any particular order. By applying the method and/or using the system disclosed herein, the latent fingerprints are not disturbed. Thus there is no need to apply dusting, super-glue fuming, and/or other non-optical imaging techniques which result in material coming into direct contact with the latent image.

Persons skilled in the art will recognize that an apparatus, such as a data processing system, including a CPU, memory, I/O, program storage, a connecting bus, and other appropriate components, could be programmed or otherwise designed to facilitate the practice of embodiments of the method. Such a system would include appropriate program means for executing the method. Also, an article of manufacture, such as a pre-recorded disk, computer readable media, or other similar computer program product, for use with a data processing system, could include a storage medium and program means recorded thereon for directing data processing system to facilitate the practice of the method.

Embodiments may also be described in the general context of computer-executable instructions, such as program modules, being executed by any device such as, but not limited to, a computer, designed to accept data, perform prescribed mathematical and/or logical operations usually at high speed, where results of such operations may or may not be displayed. Generally, program modules include routines, programs, Objects, components, data structures, etc., that perform particular tasks or implement particular abstract data types. In an embodiment, the software programs that underlie embodiments can be coded in different programming languages for use with different devices, or platforms. It will be appreciated, however, that the principles that underlie the embodiments can be implemented with other types of computer software technologies as well.

Moreover, those skilled in the art will appreciate that the embodiments may be practiced with other computer system configurations, multiprocessor systems, microprocessor-based or programmable consumer electronics, minicomputers, mainframe computers, and the like. Embodiments may also be practiced in distributed computing environments where tasks are performed by processing devices located at different locations that are linked through at least one communications network. In a distributed computing environment, program modules may be located in both local and remote computer storage media including memory storage devices.

In view of the above, a non-transitory processor readable storage medium is provided. The storage medium comprises an executable computer program product which further comprises a computer software code that, when executed on a processor, causes the processor to perform certain steps or processes. Such steps include, but are not limited to, collecting optical images of a latent fingerprint at a plurality of illuminating wavelengths with at least two dimensional sensors operating in a long wave infrared emission spectrum, determining image contrast for each image measured at a specific wavelength, determining an absorption spectrum, at discrete points of the image, per image based on a detection of a high contrast being associated with low optical transmission and detection of a low contrast being associated with a high optical transmission, and comparing the determined absorption spectra at discreet image location with known spectra specific to known material to determine a material identification.

While embodiments have been described with reference to various embodiments, it will be understood by those skilled in the art that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiment disclosed as the best mode contemplated, but that all embodiments falling within the scope of the appended claims are considered. Moreover, unless specifically stated, any use of the terms first, second, etc., does not denote any order or importance, but rather the terms first, second, etc., are used to distinguish one element from another.

What is claimed is:

1. A system comprising:
an imaging device with a sensor having at least two dimensions operating in a long wave infrared emission spectrum to collect images of a latent print or a contaminant at different illuminating wavelengths;
a storage device comprising a database of known material spectra; and
a processor configured to determine an absorption spectrum per image based on a detection of high contrast being associated with low optical transmission and a detection of low contrast being associated with a high optical transmission and to compare the determined absorption spectrum with the known material spectra to determine a material identification of the latent print or the contaminant.

2. The system according to claim 1, wherein the imaging device comprises a camera.

3. The system according to claim 1, wherein the imaging device comprises an illumination source.

4. The system according to claim 1, further comprising a light measuring device configured to measure properties of light over a specific portion of an electromagnetic spectrum and configured to operate with the imaging device.

5. The system according to claim 4, wherein the light measuring device comprises a spectrometer.

6. The system according to claim 1, further comprising an intensified charged coupled device connected to the imaging device.

7. The system according to claim 4, further comprising an intensified charged coupled device connected to the light measuring device.

8. The system according to claim 1, further comprising a lens connected to the imaging device.

9. The system according to claim 4, further comprising a lens connected to the light measuring device.

10. The system according to claim 9, further comprising a plurality of fiber optic fibers configured to connect the lens to the light measuring device wherein each one fiber optic fiber of the plurality of fiber optic fibers are configured to correspond to a respective position in space.

11. The system according to claim 1, further comprising a plurality of fiber optic fibers configured to map each one fiber optic fiber of the plurality of fiber optic fibers to a respective one pixel of a plurality of pixels of the imaging device.

12. A method comprising:
collecting an optical image of a latent print or contaminant at a plurality of illuminating wavelengths with a sensor having at least two dimensions operating in a long wave infrared emission spectrum;
measuring the optical image to determine image contrast of the image at a specific wavelength;
determining an absorption spectrum, at discrete points of the image, based on a detection of a high contrast being associated with low optical transmission and detection of a low contrast being associated with a high optical transmission; and
comparing the determined absorption spectra at discreet image location with known spectra specific to known material to determine a material identification.

13. The method according to claim 12, wherein collecting the optical image comprises collecting the optical image with a camera.

14. The method according to claim 12, further comprising measuring properties of light over a specific portion of an electromagnetic spectrum when the optical image is collected.

15. The method according to claim 12, wherein measuring the optical image further comprises connecting each one fiber optic fiber of a plurality of fiber optic fibers to a lens of a device for measuring properties of light over a specific portion of an electromagnetic spectrum when the optical image is collected with each one of fiber optic fibers of the plurality of fiber optic corresponding to a position in space.

16. The method according to claim 13, wherein measuring the optical image further comprises connecting each one fiber optic fiber of a plurality of fiber optic fibers to a respective one pixel of a plurality of pixels of the camera.

17. A non-transitory processor readable storage medium, providing an executable computer program product, the executable computer program product comprising a computer software code that, when executed on a processor, causes the processor to:
collect optical images of a latent fingerprint at a plurality of illuminating wavelengths with a sensor having at least two dimensions operating in a long wave infrared emission spectrum;
determine image contrast for each image measured at a specific wavelength;
determine an absorption spectrum, at discrete points of the image, per image based on a detection of a high contrast being associated with low optical transmission and detection of a low contrast being associated with a high optical transmission; and
compare the determined absorption spectra at discreet image location with known spectra specific to known material to determine a material identification.

18. The non-transitory processor readable storage medium according to claim 17, when executed on a processor, further causes the processor to measure properties of light over a specific portion of an electromagnetic spectrum when the optical image is collected.

19. The non-transitory processor readable storage medium according to claim 17, when executed on a processor, further causes the processor to measure the optical image with each one fiber optic fiber of a plurality of fiber optic fibers connected to a lens of a device for measuring properties of light over a specific portion of an electromagnetic spectrum when the optical image is collected with each one of fiber optic fibers of the plurality of fiber optic corresponding to a position in space.
